(19) United States
(12) Patent Application Publication
(10) Pub. No.: US 2024/0119552 A1
(43) Pub. Date: Apr. 11, 2024

(54) AUTOMATED AND FIXED DEVICE BASED COMPUTATIONAL METHOD AND SYSTEM FOR THE DETERMINATION OF THE LANE WHICH A VEHICLE CROSSES, FROM A PLURALITY OF LANES OF A ROAD TOLL

(71) Applicant: Atobe - Mobility Technology, S.A., São Domingos de Rana (PT)

(72) Inventors: André Amaral Costa, São Domingos de Rana (PT); Jerónimo Francisco Pérez Regidor, São Domingos de Rana (PT); João Nuno Andrade Ribeiro, São Domingos de Rana (PT)

(21) Appl. No.: 17/962,507

(22) Filed: Oct. 9, 2022

(51) Int. Cl. G06Q 50/30; G01S 1/68; H04W 64/00

(52) U.S. Cl. CPC G06Q 50/30; G01S 1/68; H04W 64/003; G06Q 2240/00

(57) ABSTRACT

The present disclosure is enclosed in the area of validation of vehicles in road tolls, which may also be designated as tolling systems. The prior art systems require the installation of a device—a camera and/or a wireless communication device—for each lane of a toll, in order to determine that a vehicle has crossed such lane of the toll. The present solution allows that, only with two fixed wireless devices which receive wireless beacons from a mobile device, the lane which the vehicle crosses is still determinable. This also enables that each of the fixed wireless devices may be placed in locations of the toll which are accessible without closing the lane, and thereby does not require that the circulation of vehicles has to closed, whichever is the lane. The present solution thereby promotes retrofit in existing tolls with multiple lanes.

### FIELD OF THE DISCLOSURE

The present disclosure is enclosed in the area of validation of vehicles in road tolls, which may also be designated as tolling systems.

### PRIOR ART

Solutions exist in the art where a vehicle which crosses a road toll is identified through artificial vision—namely including cameras. The images captured by a camera are automatically analysed and the license plate of the vehicle allows to determine the license plate number of the vehicle, thereby identifying the vehicle.

These systems are typically complemented with wireless communication solutions, usually involving an application-specific device, containing a unique identifier, which is detected by a wireless reader associated with the toll when the vehicle crosses the toll. Such application specific devices are typically coupled to the windshield of the vehicles, to make sure that the reader is able to detect its presence.

A further addition to the application-specific devices consists of systems in which a user of a vehicle crossing a toll subscribes a service with other third-party companies, other than the highway operator.

Such systems are based on artificial vision—using cameras —, also meaning that they are more prone to the respective issues, including failure in clearly reading a license plate number, be it due to bad condition of the plates, high speed of the vehicle or environmental conditions.

Whichever is the case, the prior art systems require the installation of a device—a camera and/or a wireless communication device—for each lane of a toll, in order to determine that a vehicle has crossed such lane of the toll. When vision is used, the camera is associated with the lane and identifies that a vehicle has crossed such lane. When wireless communications are used, a combination with a camera may be needed to confirm that a vehicle has crossed a specific lane.

When one of such systems is installed in a pre-existing toll with multiple adjacent lanes, the circulation of vehicles in each lane has to closed, in order for the camera and/or the wireless communication device to be installed.

The present disclosure provides innovative solutions to such problems, in a non-obvious manner.

### SUMMARY OF THE DISCLOSURE

It is an object of the present disclosure to provide an automated computational method for the determination of the lane which a vehicle crosses, from a plurality of adjacently provided lanes of a toll, the number of lanes being higher than the number of fixed wireless devices (thus, at least three). This method may comprise the steps of:
a mobile device issues a wireless beacon,
a first fixed wireless communication device associated with the toll receives the wireless beacon,
a second fixed wireless communication device associated with the toll receives the wireless beacon,
   wherein, based on the wireless beacon as received by the first fixed wireless communication device and on the wireless beacon as received by the second fixed wireless communication device, a position value of the mobile device is determined, and based on the position value and on information on the number of lanes of the toll, the lane which the vehicle crosses is determined, and
   wherein the position value is determined for a receipt of the wireless beacon by the first fixed wireless communication device and a receipt of the wireless beacon by the second fixed wireless communication device which occur within a time lapse which does not exceed a predefined maximum time lapse value.

For instance, it may be that the position value is determined when the wireless beacon is received by the first fixed wireless communication device and the first second wireless communication device within a time lapse of no more than 1 s, optionally no more than 900 ms, 800 ms, 700 ms, 600 ms, 500 ms, 400 ms, 300 ms, 200 ms, or 100 ms.

Such method allows that, only with two fixed wireless devices, the lane which the vehicle crosses is still determinable. This also enables that each of the fixed wireless devices may be placed in locations of the toll which are accessible without closing the lane, and thereby does not require that the circulation of vehicles has to be closed, whichever is the lane. The present solution thereby promotes retrofit in existing tolls with multiple lanes.

Particularly, the toll may comprise a plurality of lanes adjacently provided and suitable for vehicles to cross, having:
a first edge lane and a second edge lane, wherein to each a single other lane is adjacent, and
one or more inner lanes to which only two other lanes are adjacent,
   wherein the first fixed wireless communication device is coupled to the first edge lane and the second fixed wireless communication device is coupled to the second edge lane.

Which further improves the availability of access to the lanes, for installation of the fixed wireless communication devices.

The position value of the mobile device may be determined based on the signal strength of the wireless beacon as received at the first wireless communication device and on the signal strength of the wireless beacon as received at the first wireless communication device.

The wireless beacon may be issued according to a wireless local area network protocol, optionally a protocol compliant with IEEE 802.11, preferably Bluetooth, Wi-Fi or Bluetooth Low Energy, or IEEE 802.15.4.

A lane has a width, the width corresponding to an extension which exclusively corresponds to a single lane, along a direction in which the plurality of lanes are adjacently arranged, thereby being substantially parallel to a road plane and substantially perpendicular to a direction of the movement of the vehicle while crossing the lane. All the lanes may have a same width.

Based on the position value, on information on the number of lanes of the toll and on the width of each toll, the lane which the vehicle crosses may be determined.

The lanes may be physically separated with partitions, the partitions being such that cause the vehicle to cross a single lane.

The wireless beacon may be periodically issued.

Based on unique information associated with the toll, the number of lanes of the toll may be determined, through a database which associates a number of lanes of a toll with a unique information associated with the toll.

The method may be such that:
a wireless receiving sensitivity of the first fixed wireless communication device is such that it is able to receive a wireless beacon from a mobile device issued from any of the lanes, and
a wireless receiving sensitivity of the second fixed wireless communication device is such that it able to receive a wireless beacon from a mobile device issued from any of the lanes.

It may be that, prior to issuing the wireless beacon, the mobile device receives a message containing information to cause the mobile device to issue the wireless beacon, such message being issued by the first fixed wireless communication device or the second fixed wireless communication device.

The first and the second fixed wireless communication devices may respectively issue a first and a second validation message to a remote backend server, the validation messages comprising a unique information associated with the toll, the position value, and a unique information associated with the respective mobile device, and wherein the backend server determines the lane which the vehicle crosses is determined.

Alternatively, upon receipt of a wireless beacon from a same mobile device at the first and the second fixed wireless communication devices, one of the first and the second fixed wireless communication devices may issue a validation message to a remote backend server, the validation message comprising a unique information associated with the toll, the position value or signal strength values of the wireless beacon as received by the first and the second fixed wireless communication devices, and a unique information associated with the respective mobile device, and wherein the backend server determines the lane which the vehicle crosses is determined.

The validation message may be issued to a remote backend server by means of a cellular wireless network, optionally the cellular wireless network being in accordance with 2.5G GPRS, 2.75G EDGE, 3G, 4G or 5G, or by means of a cabled network.

The present disclosure may further include an automated computational system for the determination of the lane which a vehicle crosses, from a plurality of adjacently provided lanes of a toll. This system may comprise:
a mobile device configured to issue a wireless beacon,
a first fixed wireless communication device associated with the toll,
a second fixed wireless communication device associated with the toll,
   wherein, the system is configured to, upon receipt of the wireless beacon at the first and the second wireless communication devices:
determine a position value of the mobile device, based on the wireless beacon as received by the first fixed wireless communication device and on the wireless beacon as received by the second fixed wireless communication device, and
determine the lane which the vehicle crosses, based on the position value and on information on the number of lanes of the toll, the lane which, and
   wherein the system is further configured such that the position value is determined for a receipt of the wireless beacon by the first fixed wireless communication device and a receipt of the wireless beacon by the second fixed wireless communication device which occur within a time lapse which does not exceed a predefined maxim time lapse value.

In one or more embodiments, the system of the present disclosure is configured to implement the method of the present disclosure, in any of its embodiments.

The system may further comprise a remote backend server, and

the first and/or the second fixed wireless communication device is further configured to issue a validation message comprising a unique information associated with the toll, the position value or the signal strength values of the wireless beacon as received by the first and the second fixed wireless communication devices, and a unique information associated with the respective mobile device, directed to the remote backend server, and
the remote backend server being configured to, based on the position value and on information on the number of lanes of the toll, determine the lane which the vehicle crosses.

The present disclosure may further comprise a computer program product comprising executable instructions for performing the method of the present disclosure, in any of its embodiments.

The present disclosure may further comprise a non-transitory storage media including program instructions executable to carry out the method of the present disclosure, in any of its embodiments.

### DESCRIPTION OF FIGURES

FIG. 1—representation of an embodiment of the method (100) of the present disclosure, comprising the steps of: a mobile device issues a wireless beacon (110), a first fixed wireless communication device associated with the toll receives the wireless beacon (121), a second fixed wireless communication device associated with the toll receives the wireless beacon (122), wherein, based on the wireless beacon as received by the first fixed wireless communication device and on the wireless beacon as received by the second fixed wireless communication device, a position value of the mobile device is determined (130), and based on the position value and on information on the number of lanes of the toll, the lane which the vehicle crosses is determined (140), and wherein the position value is determined for a receipt of the wireless beacon by the first fixed wireless communication device and a receipt of the wireless beacon by the second fixed wireless communication device which occur within a time lapse which does not exceed a predefined maxim time lapse value (not shown).

FIG. 2—representation of an embodiment of the system (10) of the present disclosure, provided in a toll (4) with four lanes (3). A vehicle (5) crosses the second lane (3), considering that the first lane (3) is the one provided most to the left. The lane (3) provided most to the left and the lane (3) provided most to the right are edge lanes (3). The other two lanes (3) are inner lanes (3). Associated to the vehicle (5) is a mobile device (21), which may consist of a smartphone. The first fixed wireless communication device (11) is provided on the edge lane (3) to the left, also called first lane (3). The second fixed wireless communication device (12) is provided on the edge lane (3) to the right, also called fourth lane (3). The signal strength of a wireless beacon issued by the mobile device (21) as received by the first fixed wireless communication device (11) will be higher than the signal strength of the wireless beacon as received by the second fixed wireless communication device (12), when received by the mobile device (21) and for a same wireless receiving sensitivity of the two fixed wireless communication devices (11, 12). In this representation, the vehicle (5)—a car—is moving perpendicularly to the plane of the drawing sheet. The several elements of FIG. 2: vehicle (5), mobile device (21), fixed wireless communication devices (11, 12), lanes (3), road toll (4), are not represented at scale.

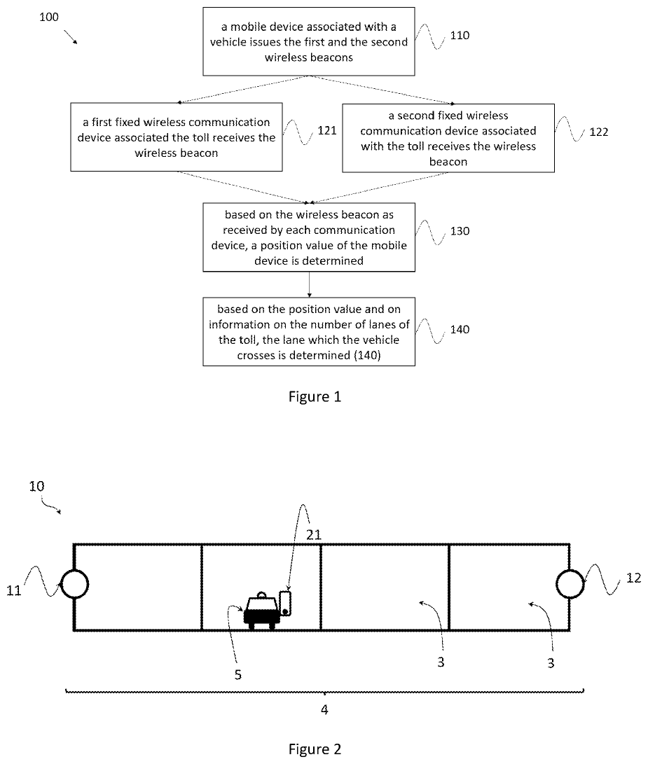

### DETAILED DESCRIPTION

Several configurations of the objects of the present disclosure are described in the Summary of the disclosure. Such configurations are further described below.

The toll includes a section of a road, which vehicles cross through individualized lanes adjacently provided along the section, and which define the toll. Vehicles cross such toll in a single driving way or in two driving ways. For instance, half the lanes may be attributed to a certain driving way and another half to the opposite driving way. Typically, this means entering or exiting the controlled access area which the road toll limits. Crossing the toll may involve the payment of a value associated with a route or with the access to the road in such area, which a vehicle associated with a mobile device has crossed. The present disclosure involves the determination of the lane which the vehicle to which a mobile device is associated has crossed, which may also include determining if the vehicle is moving in a driving way or in the opposite driving way.

Thus, a vehicle crosses a lane of a road toll by passing through an individualized area, formed along a direction in which lanes are the adjacently arranged. The solution of the present disclosure allows to efficiently determine which is the lane which the road vehicle has crossed or passed through, from the plurality of lanes. FIG. 2 represents a vehicle crossing a lane.

The toll includes a plurality of lanes. The number of lanes is higher than the number of fixed wireless devices. Thus, with two fixed wireless devices, the number of lanes is of at least 3. The number of lanes may be of 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60.

The fact that a wireless beacon is used allows that no connection has to be established between any of the fixed wireless communication devices and the mobile device.

Based on the wireless beacon as received in the first and in the second fixed wireless communication devices, a position value of the mobile device is determined.

The position value of the mobile device may be determined in respect of a predefined referential.

Such referential may include the setting of a reference position along an imaginary line along the adjacently provided lanes.

The position value may include a first distance to the first fixed wireless communication device and a second distance to the second fixed wireless communication device. In such case, the determination of the lane in which the mobile device has passed is based on the said first and second distances.

It may be that one or both of the fixed wireless communication devices determines such position value, or that another element of the system determines the position value.

As referred, the present method allows that only with two fixed wireless devices, the lane which the vehicle crosses is still determinable. This is further provided by a triangulation performed by the receipt of the wireless beacon by the two fixed wireless communication devices, wherein the distance between such fixed wireless communication devices is known.

As referred, such solution allows that each of the fixed wireless devices may be placed in locations of the toll which are accessible without closing any lane, and thereby does not require that the circulation of vehicles has to be closed, whichever is the lane, and enabling retrofit.

The first and the second fixed wireless communication devices are provided along the toll. A particular solution, which provides further access since such fixed devices are provided in the edges, is that:
a first edge lane and a second edge lane, wherein to each a single other lane is adjacent, and
one or more inner lanes to which only two other lanes are adjacent,
   wherein the first fixed wireless communication device is coupled to the first edge lane and the second fixed wireless communication device is coupled to the second edge lane.

The toll may comprise a plurality of lanes adjacently provided and suitable for vehicles to pass or cross in a single driving way or in two driving ways. The present solution is able to operate even when road vehicles are crossing a set of lanes in a first driving way and road vehicles are crossing another set of lanes in a second driving way, which is opposite to the first. The solution still enables to determine which is the lane that the vehicle has crossed. From such information, the driving way is also determinable.

The wireless beacon may comprise a unique information associated the mobile device.

Based on a unique information associated with the toll, which may be provided in one or both of the fixed wireless communication devices, the number of lanes of the toll may be determined.

For instance, through a database which associates a number of lanes of a toll with a unique information associated with the toll.

The position value (or, for instance, the first distance value and the second distance) may be respectively determined based on the signal strength of the wireless beacon as received by the first fixed wireless communication device and on the signal strength of the wireless beacon as received by the second fixed wireless communication device. Such determination is enabled through triangulation, as previously explained.

The wireless beacon may be issued according to a wireless local area network protocol. The protocol may be compliant with IEEE 802.11. Examples of protocols, referred to through their known commercial name, are Bluetooth, Wi-Fi or Bluetooth Low Energy, or IEEE 802.15.4, whichever is the version.

A lane has a width such that road vehicles may cross the lane. The width may be described as corresponding to an extension which exclusively corresponds to a single lane, along a direction in which the plurality of lanes are adjacently arranged. Another way to define such direction is that it is substantially parallel to a road plane and substantially perpendicular to a direction of the movement of the vehicle while crossing the lane. All the lanes may have a same width, which enables the simplification of the determination of the lane which the vehicle crosses.

The width of the lane is such that different types of road vehicles may cross the lane, e.g. those which are authorized to run in public roads, including: motorcycles, cars with different sizes, including SUVs, or trucks of different sizes.

Based on the position value (e.g. the first and second distance values), on information on the number of lanes of the toll and on the width of each toll, the lane which the vehicle crosses may be more specifically determined.

The lanes may be physically separated with partitions, the partitions being such that cause the vehicle to cross a single lane. Such partitions are regular partitions known in the art, and which physically separate lanes.

The wireless beacon may be periodically issued, providing that the fixed wireless communication devices may continuously receive beacons from a vehicle approaching the toll.

For several received wireless beacons at a same fixed wireless communication device from a same mobile device, a position value of the mobile device when it crosses the lane may be determined as the one which maximizes the signal strengths in the two fixed wireless communication devices. Such solution is particularly applicable when the vehicle drives in a straight trajectory and perpendicularly to the toll, the direction along the adjacently provided lanes which form the toll.

Furthermore, the method may be such that it provides that triangulation is available for all lanes, in particular by providing that:
a wireless receiving sensitivity of the first fixed wireless communication device is such that it is able to receive a wireless beacon from a mobile device issued from any of the lanes, and
a wireless receiving sensitivity of the second fixed wireless communication device is such that it able to receive a wireless beacon from a mobile device issued from any of the lanes.

Such solution may be provided for a predefined minimum transmit wireless power of the mobile device. Such predefined minimum transmit wireless power of the mobile device may be such that it is receivable by the first and the second fixed wireless communication devices having the referred respective wireless receiving sensitivities.

It may be that, prior to issuing the wireless beacon, the mobile device receives a message—which may be called an activation message—containing information to cause the mobile device to issue the wireless beacon, such message being issued by the first fixed wireless communication device or the second fixed wireless communication device. The mobile device may be configured to initiate an active mode in which it issues the wireless beacon, upon receipt of the said message containing information to cause the mobile device to issue the wireless beacon. Prior to initiating said active mode, the mobile device may be in a low power mode. The said activation message may, thus, be causing a wake-up action to the mobile device. The activation message may be compliant with the protocol whose commercial name is iBeacon, in any of its versions. The said activation message may also, be causing a computer program or app which provides the issuing of wireless beacons by the mobile device to be initiated.

The first and the second fixed wireless communication devices may respectively issue a first and a second validation message to a remote backend server, the validation messages comprising a unique information associated with the toll, the position value (which may consist of the first and second distance values) or signal strength values of the wireless beacon as received by the first and the second fixed wireless communication devices, and a unique information associated with the respective mobile device, and wherein the backend server determines the lane which the vehicle crosses is determined.

Alternatively, upon receipt of a wireless beacon from a same mobile device at the first and the second fixed wireless communication devices, one of the first and the second fixed wireless communication devices may issue a validation message to a remote backend server, the validation message comprising a unique information associated with the toll, the position value (which may consist of the first and second distance values) or signal strength values of the wireless beacon as received by the first and the second fixed wireless communication devices, and a unique information associated with the respective mobile device, and wherein the backend server determines the lane which the vehicle crosses is determined.

The previously referred database may be associated with the backend server, and/or the backend server may be in communication with such database.

The validation message may be issued to a remote backend server by means of a cellular wireless network The cellular wireless network protocol may be in accordance with one of the following protocols, referred to through their commercial name, 2.5G GPRS, 2.75G EDGE, 3G, 4G or 5G, or by means of a cabled network.

The method may also comprise that optical means are associated with the fixed wireless communication devices, the optical means being so arranged that are able to capture a digital image of a vehicle associated with a mobile device crossing any of the lanes. The optical means may consist of one or more digital cameras. Based on such image and on the position value, a confirmation that a unique information associated with the mobile device corresponds to the vehicle provided in the image may be performed.

The present disclosure may further include an automated computational system for the determination of the lane which a vehicle crosses, from a plurality of adjacently provided lanes of a toll.

In one or more embodiments, the system of the present disclosure is configured to implement the method of the present disclosure, in any of its embodiments.

The mobile device may consist of a phone, smartphone or a tablet or another device with wireless communication capabilities and with mobility capabilities.

Although the present disclosure is mainly described in terms of methods and systems, the person skilled in the art understands that it is also directed to various devices or apparatuses, such as a mobile device, the first and/or the second fixed wireless device, the optical means, and/or the backend server.

The mobile device, the first and/or the second fixed wireless device, the optical means, and/or the backend server include components to perform at least some of the example features and features of the methods described, whether through hardware components (such as memory and/or processor), software or any combination thereof.

An article for use with the mobile device, the first and/or the second fixed wireless device, the optical means, and/or the backend server, such as a pre-recorded storage device or other similar computer-readable medium, including program instructions recorded on it, or a computer data signal carrying readable program instructions computer can direct a device to facilitate the implementation of the methods described herein. It is understood that such apparatus, articles of manufacture and computer data signals are also within the scope of the present disclosure.

A “computer-readable medium” means any medium that can store instructions for use or execution by a computer or other computing device, including read-only memory (ROM), erasable programmable read-only memory (EPROM) or flash memory, random access memory (RAM), a portable floppy disk, a drive hard drive (HDD), a solid state storage device (for example, NAND flash or synchronous dynamic RAM (SDRAM)), and/or an optical disc such as a Compact Disc (CD), Digital Versatile Disc (DVD) or Blu-Ray™ Disc.

As will be clear to one skilled in the art, the present disclosure should not be limited to the embodiments described herein, and a number of changes are possible which remain within the scope of the present disclosure.

Of course, the preferred embodiments shown above are combinable, in the different possible forms, being herein avoided the repetition all such combinations.

1. An automated computational method for the determination of the lane which a vehicle crosses, from a plurality of adjacently provided lanes of a road toll, the number of lanes being higher than the number of fixed wireless devices, characterised in that it comprises the steps of:
a mobile device issues a wireless beacon,
a first fixed wireless communication device associated with the toll receives the wireless beacon,
a second fixed wireless communication device associated with the toll receives the wireless beacon,
wherein, based on the wireless beacon as received by the first fixed wireless communication device and on the wireless beacon as received by the second fixed wireless communication device, a position value of the mobile device is determined, and
based on the position value and on information on the number of lanes of the toll, the lane which the vehicle crosses is determined, and
wherein the position value is determined for a receipt of the wireless beacon by the first fixed wireless communication device and a receipt of the wireless beacon by the second fixed wireless communication device which occur within a time lapse which does not exceed a predefined maxim time lapse value.

2. A method according to claim 1 wherein the toll comprises a plurality of lanes adjacently provided and suitable for vehicles to cross having:
a first edge lane and a second edge lane, wherein to each a single other lane is adjacent, and
one or more inner lanes to which only two other lanes are adjacent,
wherein the first fixed wireless communication device is coupled to the first edge lane and the second fixed wireless communication device is coupled to the second edge lane.

3. A method according to claim 1 wherein the position value of the mobile device is determined based on the signal strength of the wireless beacon as received at the first wireless communication device and on the signal strength of the wireless beacon as received at the first wireless communication device.

4. A method according to claim 1 wherein the wireless beacon is issued according to a wireless local area network protocol, optionally a protocol compliant with IEEE 802.11, preferably Bluetooth, Wi-Fi or Bluetooth Low Energy, or IEEE 802.15.4.

5. A method according to claim 1 wherein a lane has a width, the width corresponding to an extension which exclusively corresponds to a single lane, along a direction in which the plurality of lanes are adjacently arranged, thereby being substantially parallel to a road plane and substantially perpendicular to a direction of the movement of the vehicle while crossing the lane.

6. A method according to the claim 5 wherein all the lanes have a same width.

7. A method according to claim 5 wherein, based on the position value, on information on the number of lanes of the toll and on the width of each toll, the lane which the vehicle crosses is determined.

8. A method according to claim 1 wherein the lanes are physically separated with partitions, the partitions being such that cause the vehicle to cross a single lane.

9. A method according to claim 1, wherein the wireless beacon is periodically issued.

10. A method according to claim 1 wherein, based on unique information associated with the toll, the number of lanes of the toll is determined, through a database which associates a number of lanes of a toll with a unique information associated with the toll.

11. A method according to claim 1 wherein:
a wireless receiving sensitivity of the first fixed wireless communication device is such that it is able to receive a wireless beacon from a mobile device issued from any of the lanes, and
a wireless receiving sensitivity of the second fixed wireless communication device is such that it able to receive a wireless beacon from a mobile device issued from any of the lanes.

12. A method according to claim 1 wherein, prior to issuing the wireless beacon, the mobile device receives a message containing information to cause the mobile device to issue the wireless beacon, such message being issued by the first fixed wireless communication device or the second fixed wireless communication device.

13. A method according to claim 1 wherein:
the first and the second fixed wireless communication devices respectively issue a first and a second validation message to a remote backend server, the validation messages comprising a unique information associated with the toll, the position value, and a unique information associated with the respective mobile device, and
wherein the backend server determines the lane which the vehicle crosses is determined, or
upon receipt of a wireless beacon from a same mobile device at the first and the second fixed wireless communication devices, one of the first and the second fixed wireless communication devices issue a validation message to a remote backend server, the validation message comprising a unique information associated with the toll, the position value or signal strength values of the wireless beacon as received by the first and the second fixed wireless communication devices, and a unique information associated with the respective mobile device, and wherein the backend server determines the lane which the vehicle crosses is determined.

14. A method according to claim 13 wherein the validation message is issued to a remote backend server by means of a cellular wireless network, optionally the cellular wireless network being in accordance with 2.5G GPRS, 2.75G EDGE, 3G, 4G or 5G, or by means of a cabled network.

15. An automated computational system for the determination of the lane which a vehicle crosses, from a plurality of adjacently provided lanes of a road toll, the number of lanes being higher than the number of fixed wireless devices, characterised in that it comprises:
a mobile device configured to issue a wireless beacon,
a first fixed wireless communication device associated with the toll,
a second fixed wireless communication device associated with the toll,
wherein, the system is configured to, upon receipt of the wireless beacon at the first and the second wireless communication devices:
determine a position value of the mobile device, based on the wireless beacon as received by the first fixed wireless communication device and on the wireless beacon as received by the second fixed wireless communication device, and
determine the lane which the vehicle crosses, based on the position value and on information on the number of lanes of the toll, the lane which, and
wherein the system is further configured such that the position value is determined for a receipt of the wireless beacon by the first fixed wireless communication device and a receipt of the wireless beacon by the second fixed wireless communication device which occur within a time lapse which does not exceed a predefined maxim time lapse value.

16. A system according to the claim 15 wherein it is configured to implement an automated computational method for the determination of the lane which a vehicle crosses, from a plurality of adjacently provided lanes of a road toll, the number of lanes being higher than the number of fixed wireless devices, the method comprising the steps of:
a mobile device issues a wireless beacon,
a first fixed wireless communication device associated with the toll receives the wireless beacon,
a second fixed wireless communication device associated with the toll receives the wireless beacon,
wherein, based on the wireless beacon as received by the first fixed wireless communication device and on the wireless beacon as received by the second fixed wireless communication device, a position value of the mobile device is determined, and
based on the position value and on information on the number of lanes of the toll, the lane which the vehicle crosses is determined, and
wherein the position value is determined for a receipt of the wireless beacon by the first fixed wireless communication device and a receipt of the wireless beacon by the second fixed wireless communication device which occur within a time lapse which does not exceed a predefined maxim time lapse value.

17. A system according to claim 15 wherein it further comprises a remote backend server, and
the first and/or the second fixed wireless communication device is further configured to issue a validation message comprising a unique information associated with the toll, the position value or the signal strength values of the wireless beacon as received by the first and the second fixed wireless communication devices, and a unique information associated with the respective mobile device, directed to the remote backend server, and
the remote backend server being configured to, based on the position value and on information on the number of lanes of the toll, determine the lane which the vehicle crosses.

18. A computer program product comprising executable instructions for performing an automated computational method for the determination of the lane which a vehicle crosses, from a plurality of adjacently provided lanes of a road toll, the number of lanes being higher than the number of fixed wireless devices, the method comprising the steps of:
a mobile device issues a wireless beacon,
a first fixed wireless communication device associated with the toll receives the wireless beacon,
a second fixed wireless communication device associated with the toll receives the wireless beacon,
wherein, based on the wireless beacon as received by the first fixed wireless communication device and on the wireless beacon as received by the second fixed wireless communication device, a position value of the mobile device is determined, and
based on the position value and on information on the number of lanes of the toll, the lane which the vehicle crosses is determined, and
wherein the position value is determined for a receipt of the wireless beacon by the first fixed wireless communication device and a receipt of the wireless beacon by the second fixed wireless communication device which occur within a time lapse which does not exceed a predefined maxim time lapse value.

19. (canceled)
